(19) United States
(12) Patent Application Publication
(10) Pub. No.: US 2005/0068764 A1
(43) Pub. Date: Mar. 31, 2005

(54) Luminescent connective apparatus for wrench

(76) Inventor: Terence Chen, Yi Lan Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/700,654

(22) Filed: Nov. 3, 2003

(30) Foreign Application Priority Data
Sep. 30, 2003 (TW) 92127127

(51) Int. Cl. B25B 23/18

(52) U.S. Cl. 362/119

(57) ABSTRACT

A luminescent connective apparatus is provided for connecting a wrench with a socket. The luminescent connective apparatus includes a joint defining a tunnel, a lighting device installed in the tunnel and a switch assembly installed on the joint so that the switch assembly is operable in order to turn the lighting device on and off.

### FIELD OF INVENTION

The present invention relates to a luminescent connective apparatus via which a wrench is connected with an extensive element.

### BACKGROUND OF INVENTION

Referring to FIGS. 8 and 9, a conventional luminescent wrench includes a handle 60, a tubular extension element 62 for engagement with the handle 60 and a lighting device 64 put in the tubular extension element 62. The tubular extension element 62 can be engaged with joints 66 of various sizes. The handle 60 includes an insert 72. The tubular extension element 62 defines a first chamber 74, a second chamber 76 communicated with the first chamber 74 and a third chamber 78 communicated with the second chamber 76. The insert 72 can be put in the first chamber 74. The lighting device 64 includes a box 80, a button 82 installed at the box 80, two batteries 84 put in the box 80, a cover 86 for keeping the batteries 84 in the box 80 and a post 88 extending from the cover 84 and an LED 90 installed at the post 86. The box 80 is put in the second chamber 76 while the post 88 extends through the third chamber 78 so that the LED 90 is located outside the third chamber 78. Each joint 66 includes a first insert 92 and a second insert 94 and defines a tunnel 96. The first insert 92 can be put in the third chamber 78 while the post 88 extends in the tunnel 96 so that light can be emitted from the LED 90 to the exterior through the tunnel 96. The second insert 94 can be put in a socket 98 for driving a bolt or nut (not shown). In use, the insert 72 is inserted into the first chamber 74 so as to push the button 82, thus actuating the LED 90. However, in use of this conventional luminescent wrench, several problems have been encountered. Firstly, the LED 90 cannot be actuated unless the button 82 is pushed by means of the insert 72. Once the handle 60 is disengaged from the tubular extension element 62, the lighting device 64 cannot emit light. Hence, another light source is needed in order to find the tubular extension element 62 in the dark. Secondly, once the handle 60 is engaged with the tubular extension element 62, the lighting device 64 always emits light no matter it is necessary or not. Thirdly, tubular extension elements of various sizes and, more particularly, lengths are needed in practical use. Each tubular extension element is equipped with a lighting device. The cost of using this conventional luminescent wrench is inevitably high.

The present invention is therefore intended to obviate or at least alleviate the problems encountered in prior art.

### SUMMARY OF INVENTION

It is an objective of the present invention to provide a luminescent connective apparatus for connecting a wrench with a socket.

According to the present invention, a luminescent connective apparatus includes a joint defining a tunnel, a lighting device installed in the tunnel and a switch assembly installed on the joint so that the switch assembly is operable in order to turn the lighting device on and off.

Other objects, advantages and novel features of the invention will become more apparent from the following detailed description in conjunction with the attached drawings.

### BRIEF DESCRIPTION OF DRAWINGS

The present invention will be described via detailed illustration of two embodiments referring to the drawings.

FIG. 1 is a perspective view of a wrench and a luminescent connective apparatus according to the first embodiment of this invention.

FIG. 2 is an exploded view of the wrench and the luminescent connective apparatus of FIG. 1.

FIGS. 3-6 are cross-sectional views of the wrench and the luminescent connective apparatus of FIG. 1 in various positions.

FIG. 7 is a cross-sectional view of a wrench engaged with a socket by means of a luminescent connective apparatus according to the second embodiment of the present invention.

FIG. 8 is an exploded view of a conventional luminescent wrench.

FIG. 9 is a cross-sectional view of the luminescent wrench of FIG. 8.

### DETAILED DESCRIPTION OF EMBODIMENTS

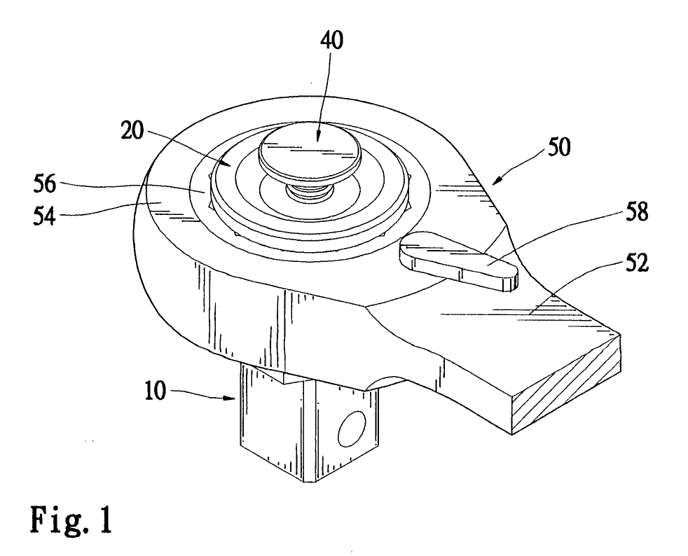

Referring to the FIGS. 1-6, according to a first embodiment of the present invention, a luminescent connective apparatus is used to connect a wrench 50 with a socket 60 or an extensive element (not shown).

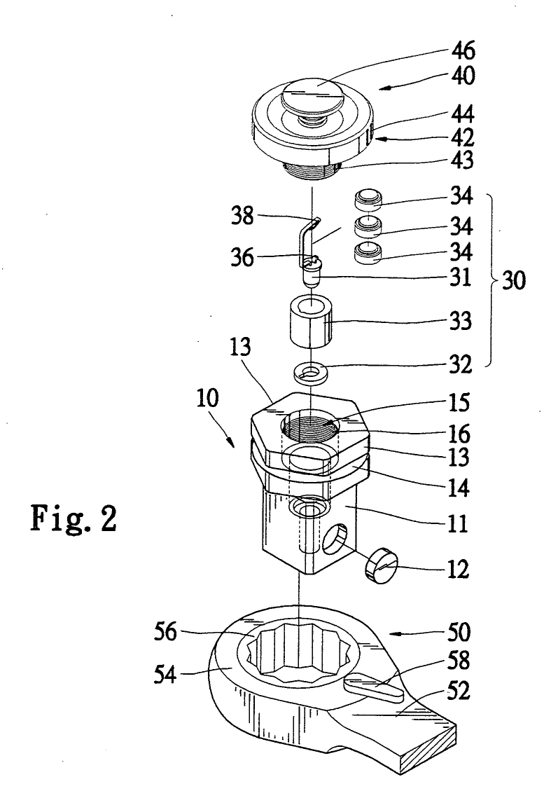

Referring to FIG. 2, the wrench 50 includes a handle 52, an annular head 54 formed at an end of the handle 52 and an annular gear 56 rotationally installed at the annular head 54. The annular head 54 can drive the annular gear 56 in selective one of two directions through a ratcheting device (not shown) arranged between the annular head 54 and the annular gear 56. The selection between the directions is done by means of a switch 58 connected with the ratcheting device.

The luminescent connective apparatus includes a joint 10, a lighting device 30 and a switch assembly 40.

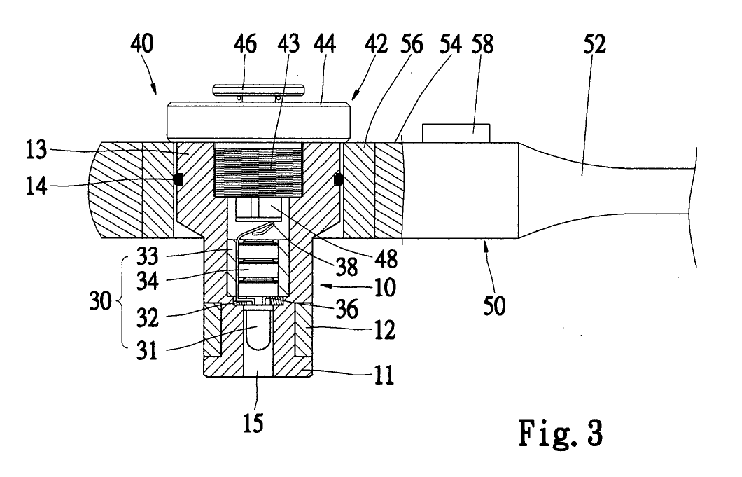

The joint 10 includes a first insert 11 and a second insert 13. Two magnets 12 (see FIG. 3) are fit in two holes (not numbered) defined in the first insert 11. A ring of rubber 14 is put in an annular groove (not numbered) defined in the second insert 13. The joint 10 defines a tunnel 15 including a first portion, a second portion communicated with the first portion, a third portion communicated with the second portion and a fourth portion communicated with the third portion. A thread 16 is formed on the wall of the fourth portion of the tunnel 15.

The lighting device 30 includes a light 31, an isolative ring 32, an isolative cylinder 33 and several batteries 34. The light 31 is preferably a light-emitting diode (“LED”) and includes a first electrode 36 and a second electrode 38 extending longer than the first electrode 36.

Referring to FIG. 3, in assembly, the electrodes 36 and 38 are inserted through the isolative ring 32. The batteries 34 are put between the electrodes 36 and 38. One of the batteries 34 is always in contact with the first electrode 36. The isolative cylinder 33 is put around the batteries 34 and the electrodes 36 and 38.

The lighting device 30 is put in the tunnel 15. The light 31 is put in the first portion of the tunnel 15. Thus, light can be emitted from the light 31 to the exterior from the first portion of the tunnel 15. The isolative ring 32 is put in the second portion of the tunnel 15.

The switch assembly 40 includes a cylinder 42 installed on the joint 10, a button 46 movably installed on the cylinder 42 and a pusher 48 (see FIGS. 3-6) operatively connected with the button 46 for pushing the second electrode 38 to the batteries 34. The cylinder 42 includes a thread 43 formed on a first portion and a ring 44 formed on a second portion. The thread 43 is engaged with the thread 16 so as to keep the cylinder 42 on the joint 10. The switch 40 is often used in ballpoint pens and will not be described in detail for being conventional.

Referring to FIG. 3, the pusher 48 is in an upper position so as to allow disengagement of the second electrode 38 from the batteries 34. That is, the lighting device 30 is off.

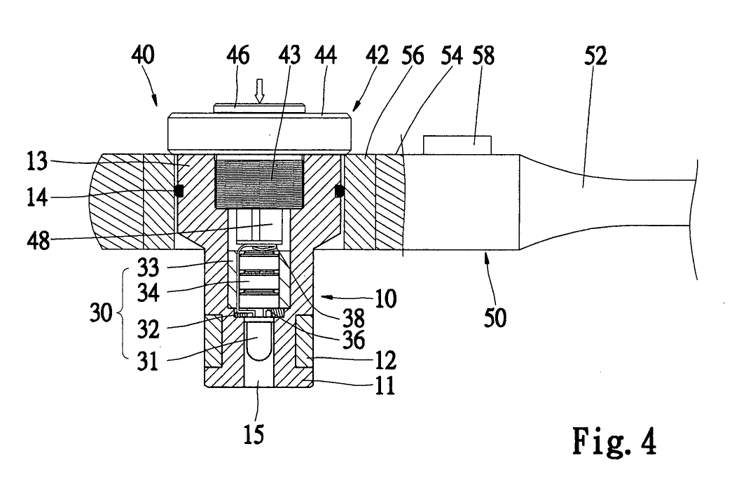

Referring to FIG. 4, the button 46 is pushed so as to move the pusher 48 to a lower position. The second electrode 38 is brought into contact with the batteries 34. Hence, the lighting device 30 is turned on.

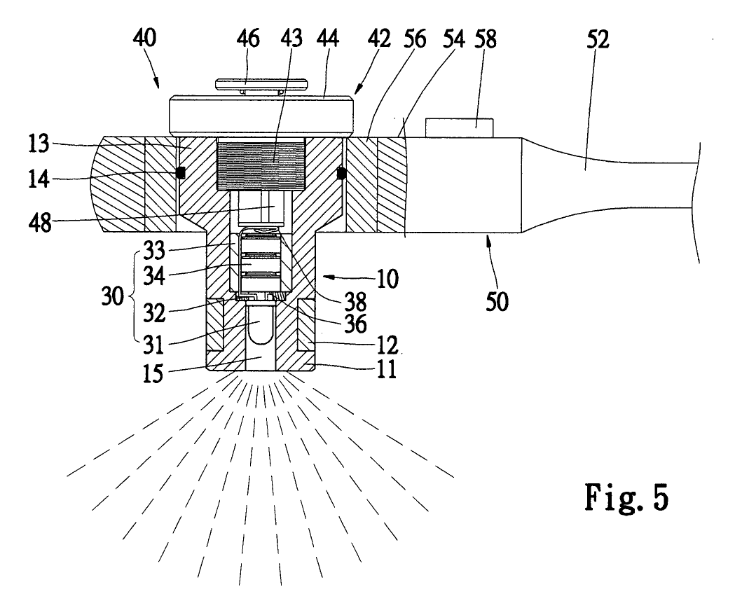

Referring to FIG. 5, when the button 46 is released, the pusher 48 is left in the lower position. Therefore, the lighting device 30 is retained on.

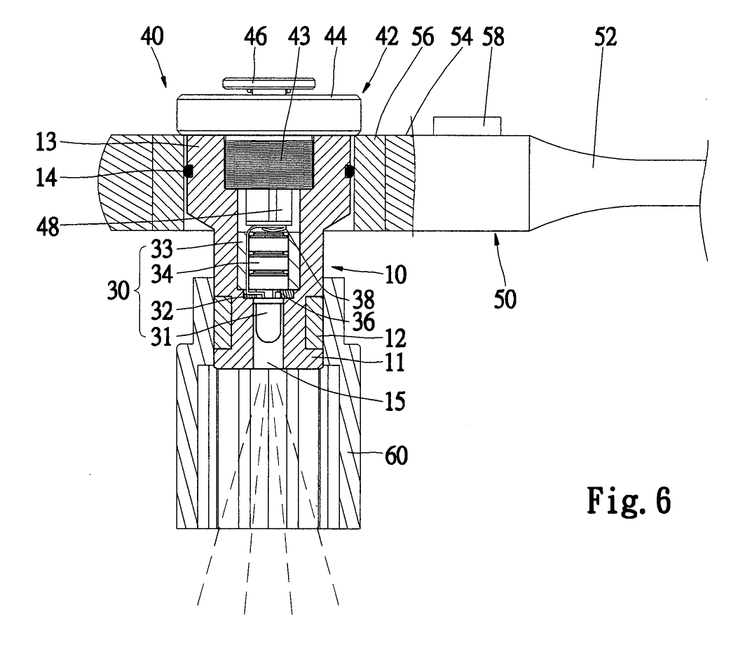

Referring to FIG. 6, the first insert 11 is insert in the socket 60. The socket 60 is attracted to the first insert 11 because of the magnets 12.

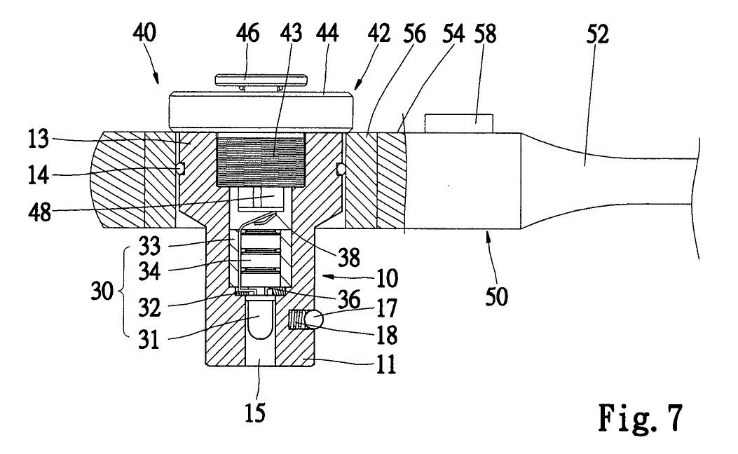

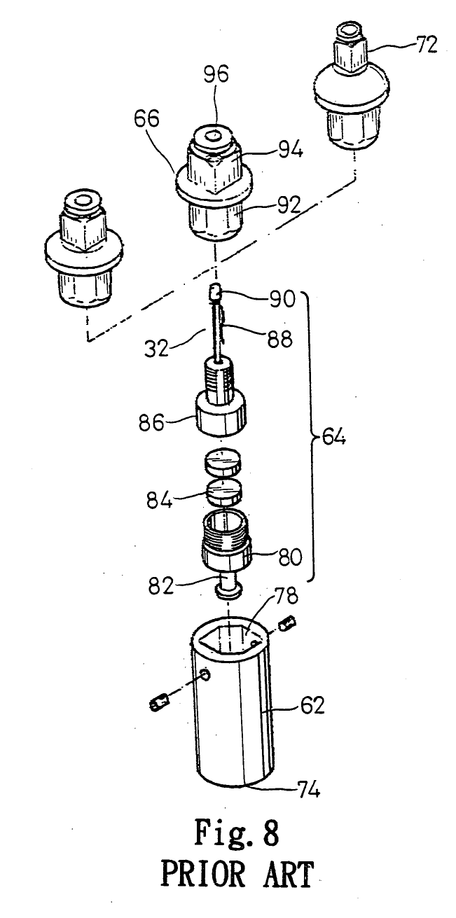

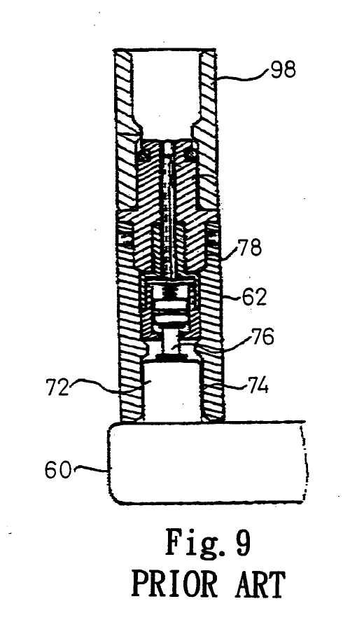

FIG. 7 shows a luminescent connective apparatus according to a second embodiment of the present invention. The second embodiment is identical to the first embodiment except for including a spring-biased detent instead of the magnets 12. The spring-biased detent includes a ball 17 trapped in a hole (not numbered) defined in the first insert 11 and a spring 18 compressed between the ball 17 and the bottom of the hole defined in the first insert.

The present invention has been described via detailed illustration of two embodiments. Those skilled in the art can derive variations from the embodiments without departing from the scope of the present invention. Therefore, the embodiments shall not limit the scope of the present invention defined in the claims.

1. A luminescent connective apparatus for connecting a wrench with a socket, the luminescent connective apparatus comprising a joint defining a tunnel, a lighting device installed in the tunnel and a switch assembly installed on the joint so that the switch assembly is operable in order to turn the lighting device on and off.

2. The luminescent connective apparatus according to claim 1 wherein the joint includes a first insert for insertion in the socket and a second insert for insertion in the wrench.

3. The luminescent connective apparatus according to claim 2 wherein the joint includes at least one magnet attached to the first insert.

4. The luminescent connective apparatus according to claim 2 wherein the joint includes at least one spring-biased detent attached to the first insert.

5. The luminescent connective apparatus according to claim 2 wherein the joint includes a ring attached to the second insert.

6. The luminescent connective apparatus according to claim 1 wherein the lighting device includes a light with a first electrode and a second electrode both extending from the light and a power supply normally in contact with the first electrode but separate from the second electrode.

7. The luminescent connective apparatus according to claim 6 wherein the power supply includes at least one battery.

8. The luminescent connective apparatus according to claim 6 wherein the lighting device includes an isolative device for electrically isolating the first and second electrodes from the joint.

9. The luminescent connective apparatus according to claim 6 wherein the light is a light-emitting diode.

10. The luminescent connective apparatus according to claim 6 wherein the second electrode extends longer than the first electrode.

11. The luminescent connective apparatus according to claim 6, wherein the switch assembly includes a cylinder installed on the joint, a button movably installed on the cylinder and a pusher operatively connected with the button for pushing the second electrode to the power supply.

12. The luminescent connective apparatus according to claim 11, wherein the joint includes a thread formed on the wall of tunnel, and the cylinder includes a thread formed thereon for engagement with the thread of the joint.
